(19) United States
(12) Patent Application Publication
(10) Pub. No.: US 2014/0000910 A1
(43) Pub. Date: Jan. 2, 2014

(54) APPARATUS WITH RIGID SUPPORT AND RELATED METHODS

(71) Applicants: Tudor Palaghita, Houston, TX (US); Fernando Garcia-Osuna, Sugar Land, TX (US); Frank Espinosa, Sugar Land, TX (US)

(72) Inventors: Tudor Palaghita, Houston, TX (US); Fernando Garcia-Osuna, Sugar Land, TX (US); Frank Espinosa, Sugar Land, TX (US)

(21) Appl. No.: 13/539,281

(22) Filed: Jun. 29, 2012

(51) Int. Cl. G01V 3/18; E21B 47/12; E21B 17/00; G01V 3/10; E21B 19/16

(52) U.S. Cl. 166/380; 324/339; 166/65.1

(57) ABSTRACT

A wellbore apparatus may include first and second tubular members aligned in end-to-end relation, and an antenna assembly coupled to at least one of the first and second tubular members. The antenna assembly may include a cylindrical housing having a circumferential recess therein, a rigid insulating support ring carried by the cylindrical housing in the circumferential recess, an antenna coil carried by the rigid insulating support ring, and an electrical connector coupled to the antenna coil. The wellbore apparatus may include resistivity processing circuitry coupled to the electrical connector to determine an electrical resistivity of a wellbore based upon the antenna coil.

### BACKGROUND

Resistivity logging tools are used to measure the resistivities of earth formations surrounding a borehole, such as in a hydrocarbon (e.g., oil, natural gas, etc.) well. One approach for performing resistivity measurements is by lowering a wireline-conveyed logging device into a wellbore after the wellbore is drilled. Another approach is to make such measurements while the well is being drilled, which is referred to as logging-while-drilling (LWD) or measurement-while-drilling (MWD). LWD or MWD techniques may allow corrective actions to be taken during the drilling processes if desired. For example, wellbore information if available in real time may be used to make adjustments to mud weights to prevent formation damage and to improve well stability. In addition, real time formation log data may be used to direct a drill bit to the desired direction (i.e., geosteering).

Generally speaking, there are two types of LWD tools for measuring formation resistivity, namely lateral tools and induction or propagation tools. Each of these tools relies on an electromagnetic (EM) measurement principle. A lateral tool may use one or more antennas or electrodes to inject low-frequency transverse magnetic fields into the formations to determine borehole and formation responses by measuring the current flow through the formations to the receivers. Lateral resistivity tools are generally responsive to azimuthal variations in formation resistivities around the borehole.

Propagation-type tools emit high-frequency electric fields into the formation to determine borehole and formation responses by measuring voltages induced in the receivers or by measuring difference responses between a pair of receivers or between the transmitter and the receiver. For example, for a propagation tool, incoming signal phases and amplitudes may be measured at each of several receivers with respect to the phases and amplitudes of the signals used to drive the transmitter. Induction-type transmitters generate magnetic fields that induce currents to flow in the formations. These currents generate secondary magnetic fields that are measured as induced voltages in receiver antennas disposed at a distance from the transmitter antenna.

### SUMMARY

A wellbore apparatus may include first and second tubular members aligned in end-to-end relation, and an antenna assembly coupled to at least one of the first and second tubular members. The antenna assembly may include a cylindrical housing having a circumferential recess therein, a rigid insulating support ring carried by the cylindrical housing in the circumferential recess, an antenna coil carried by the rigid insulating support ring, and an electrical connector coupled to the antenna coil. The wellbore apparatus may include resistivity processing circuitry coupled to the electrical connector to determine an electrical resistivity of a wellbore based upon the antenna coil.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

FIG. 1 is a schematic diagram of an LWD/MWD system including removable modular antenna assemblies in accordance with an example embodiment.

FIG. 2 is a schematic cross-sectional diagram of a modular antenna assembly and associated tubular members of FIG. 1 along line 2-2 in accordance with an example embodiment.

FIG. 3 is an enlarged schematic cross-sectional diagram of an example embodiment of a rigid insulating support ring in the antenna assembly of FIG. 2.

FIG. 4 is an enlarged schematic cross-sectional diagram of another example embodiment of a rigid insulating support ring in the antenna assembly of FIG. 2.

FIG. 5 is an enlarged schematic cross-sectional diagram of yet another example embodiment of a rigid insulating support ring in the antenna assembly of FIG. 2.

FIG. 6 is a flowchart illustrating a method for making a wellbore apparatus in accordance with an example embodiment.

### DETAILED DESCRIPTION

The present description is made with reference to the accompanying drawings, in which example embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements in different embodiments.

Generally speaking, a wellbore apparatus may include first and second tubular members aligned in end-to-end relation, and an antenna assembly coupled between the first and second tubular members. The antenna assembly may include a cylindrical housing having a circumferential recess therein, a rigid insulating support ring carried by the cylindrical housing in the circumferential recess, at least one antenna coil carried by the rigid insulating support ring, and an electrical connector coupled to the at least one antenna coil. The wellbore apparatus may also include resistivity processing circuitry coupled to the electrical connector to determine an electrical resistivity of a wellbore based upon the at least one antenna coil.

For example, the rigid insulating support ring may comprise a ceramic material. The antenna assembly may further comprise at least one member between the rigid insulating support ring and adjacent portions of the cylindrical housing. In other embodiments, the rigid insulating support ring may directly contact adjacent portions of the cylindrical housing. The antenna assembly may further comprise a first layer of insulating material between adjacent portions of the cylindrical housing and the rigid insulating support ring. The antenna assembly may comprise a second layer of insulating material filling the circumferential recess.

In other embodiments, the cylindrical housing may comprise a reduced diameter portion having a diameter smaller than an inner diameter of the rigid insulating support ring. More specifically, the resistivity processing circuitry may comprise a controller and at least one of a transmitter and receiver coupled thereto. The at least one antenna coil may comprise a plurality thereof

Another aspect is directed to a method of making a wellbore apparatus. The method may also include coupling together first and second tubular members in end-to-end relation, and coupling an antenna assembly between the first and second tubular members. The antenna assembly may include a cylindrical housing having a circumferential recess therein, a rigid insulating support ring carried by the cylindrical housing in the circumferential recess, at least one antenna coil carried by the rigid insulating support ring, and an electrical connector coupled to the at least one antenna coil. The method may include coupling resistivity processing circuitry to the electrical connector for determining an electrical resistivity of a wellbore based upon the at least one antenna coil.

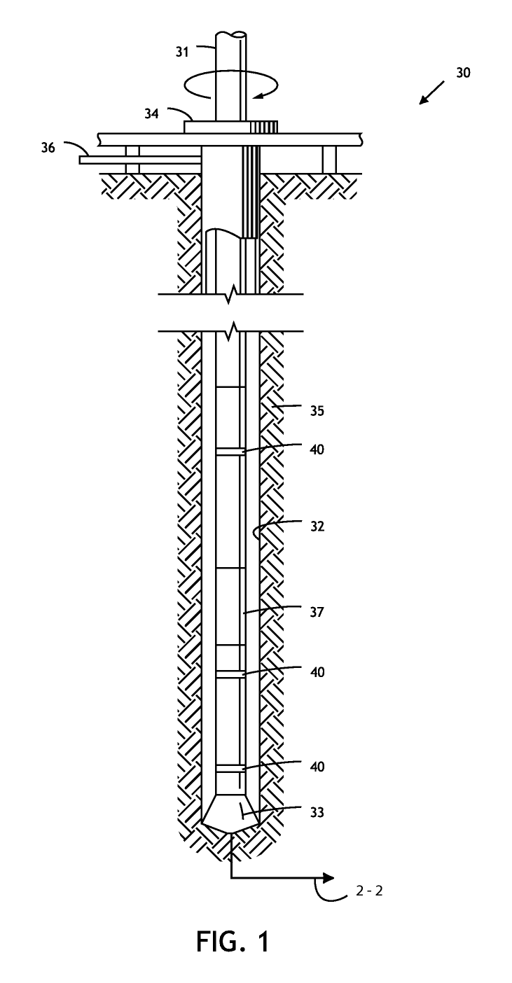

Referring initially to FIG. 1, a logging-while-drilling (LWD) or measurement-while-drilling (MWD) system 30 is first described. A drill string 31 is suspended within a borehole 32 with a drill bit 33 attached at the lower end. The drill string 31 and attached drill bit 33 are rotated by a rotating table 34 while being lowered into the well, although other approaches such as a top drive may be used instead of the rotating table. This causes the drill bit 33 to penetrate the geological formation 35. As the drill bit 33 penetrates the formation 35, drilling fluid or “mud” is pumped down through a bore of the drill string 31 (which may be a central bore, offset bore, or annular bore, for example) to lubricate the drill bit 33 and to carry cuttings from the bottom of the hole to the surface via the borehole 32 and mud flow line 36. Located behind drill bit 33 in the drill string 31 (i.e., vertically above the drill bit in FIG. 1) are sections of LWD drill collar tubulars 37, which may include a plurality of removable modular antenna assemblies 40 positioned between adjacent drill collar tubulars. The removable modular antenna assemblies 40 are used to measure the resistivity of the formation 32 as it is penetrated by the drill bit 33. It should be noted that the removable modular antenna assemblies 40, which will be discussed further below, may also be used in a wireline measurement system as well.

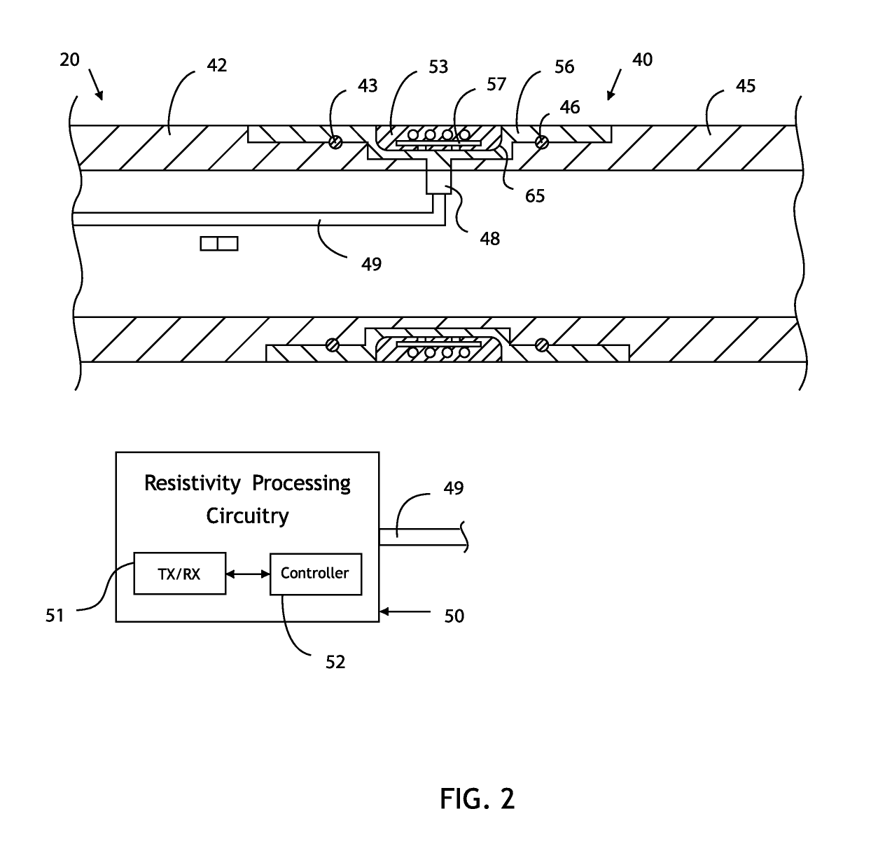

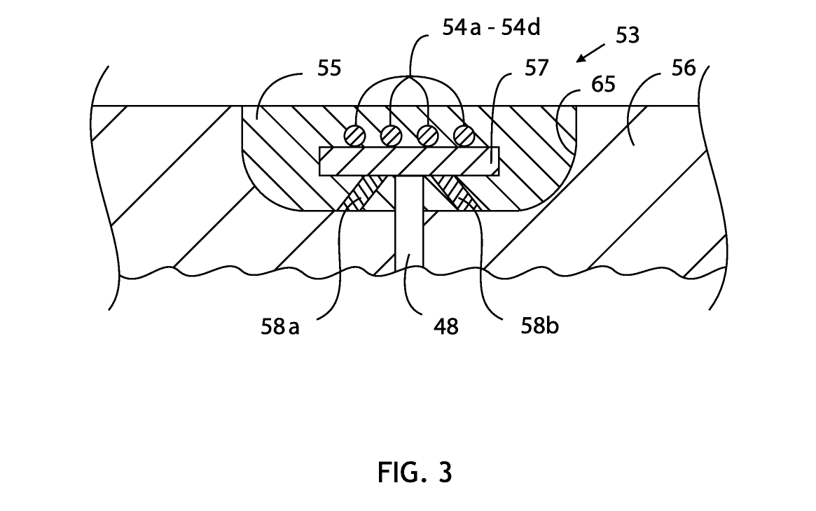

Referring more particularly to FIGS. 2-3, a wellbore apparatus 20 according to the present disclosure is now described. The wellbore apparatus 20 illustratively includes first and second tubular members 42, 45 aligned in end-to-end relation, and a modular antenna assembly 40 coupled between the first and second tubular members. As will be appreciated, the first and second tubular members 42, 45 and the antenna assembly 40 are mechanically coupled together, for example, using opposing threaded surfaces or pins, a segment at a time. Each tubular member 42, 45 illustratively includes a O-ring seal 43, 46 for providing a tight seal from the exterior of the wellbore apparatus 20.

The antenna assembly 40 illustratively includes a cylindrical housing 56 having a circumferential recess 65 therein, a rigid insulating support ring 57 carried by the cylindrical housing 56 in the circumferential recess, and a plurality of antenna coils 54a-54d carried by the rigid insulating support ring. For example, the rigid insulating support ring 57 may comprise a ceramic material. The rigid insulating support ring 57 may comprise a continuous one piece element or may comprise multiple connected sections. This may provide mechanical robustness to the wellbore apparatus 20. The antenna coils 54a-54d are aligned in relation to each other on the rigid insulating support ring 57. Additionally, the antenna assembly 40 illustratively includes an electrical connector 48 coupled to the antenna coils 54a-54d, and an electrical connector wire 49 coupled thereto.

In some embodiments, the antenna assembly 40 comprises a modular antenna assembly (FIGS. 1-2) coupled between the first and second tubular members 42, 45. In yet other embodiments, the cylindrical housing 56 is coupled around at least one of the first and second tubular members 42, 45 (i.e. the cylindrical housing 56 serves as a collar fitted over the tubular member).

The antenna assembly 40 illustratively includes resistivity processing circuitry 50 coupled to the electrical connector 48 to determine an electrical resistivity of a wellbore based upon the antenna coils 54a-54d. The resistivity processing circuitry 50 comprises a controller 52 and transmitter/receiver 51 coupled thereto.

In the illustrated embodiment, the antenna assembly 40 further comprises a pair of members 58a-58b between the rigid insulating support ring 57 and adjacent portions of the cylindrical housing 56. The antenna assembly 40 illustratively includes an insulating layer 55 over the rigid insulating support ring 57 for electrically insulating the antenna coils 54a-54d. For example, the insulating layer 55 may comprise at least one of a polymer, a rubber compound, or an elastomer. The antenna assembly 40 may provide increased stability under stress, which may allow for more accurate and sensitive measurements.

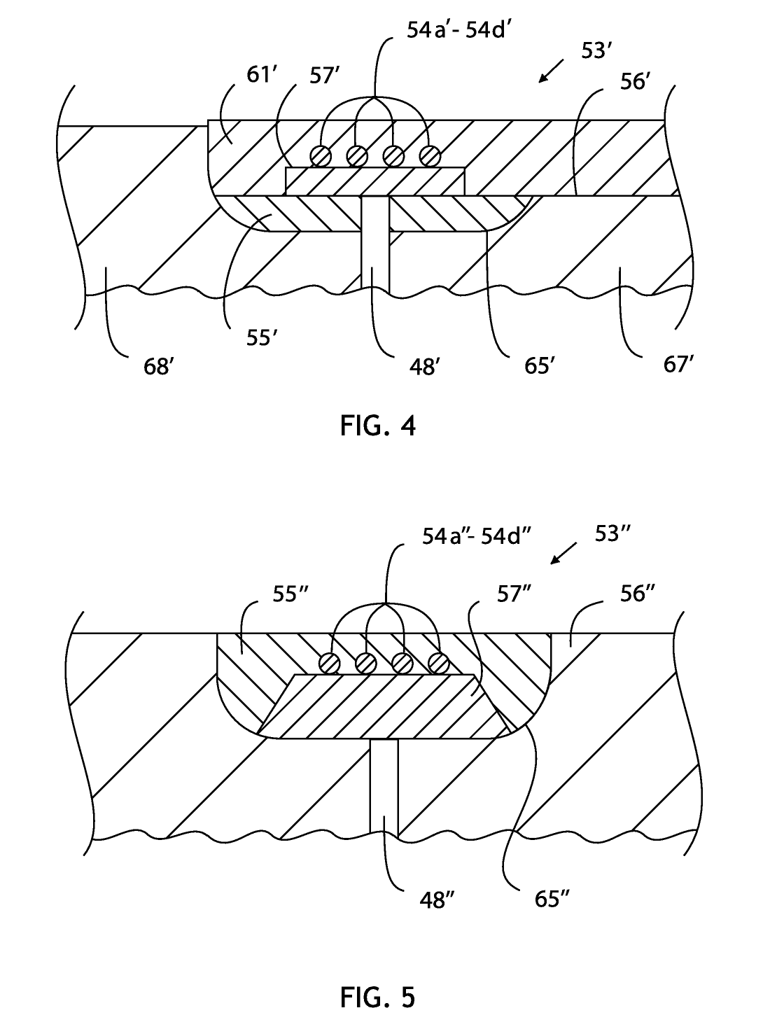

Referring now to FIG. 4, another embodiment of the antenna assembly 40′ is now described. In this embodiment of the antenna assembly 40′, those elements already discussed above with respect to FIGS. 1-3 are given prime notation and most require no further discussion herein. This embodiment differs from the previous embodiment in that the cylindrical housing 56′ comprises a reduced diameter portion 67′ having a diameter smaller than an inner diameter of the rigid insulating support ring 57′.

In the illustrated embodiment, the antenna assembly 40′ illustratively includes a first insulating layer 55′, and the rigid insulating support ring 57′ sits (floats) on top of the first insulating layer. Also, during installation, the rigid insulating support ring 57′ may be slidably fitted over the cylindrical housing 56′. The cylindrical housing 56′ illustratively includes an enlarged diameter portion 68′, on which the rigid insulating support ring 57′ may abut during installation. The antenna assembly 40′ illustratively includes a second insulating layer 61′ formed over the rigid insulating support ring 57′ and the antenna coils 54a′-54d′, covering the circumferential recess 65′.

Referring now to FIG. 5, another embodiment of the antenna assembly 40″ is now described. In this embodiment of the antenna assembly 40″, those elements already discussed above with respect to FIGS. 1-3 are given double prime notation and most require no further discussion herein. This embodiment differs from the previous embodiment in that the rigid insulating support ring 57″ directly contacts adjacent portions of the cylindrical housing 56″. In this embodiment, the rigid insulating support ring 57″ illustratively includes a plateaued top section for receiving the antenna coils 54a″-54d″.

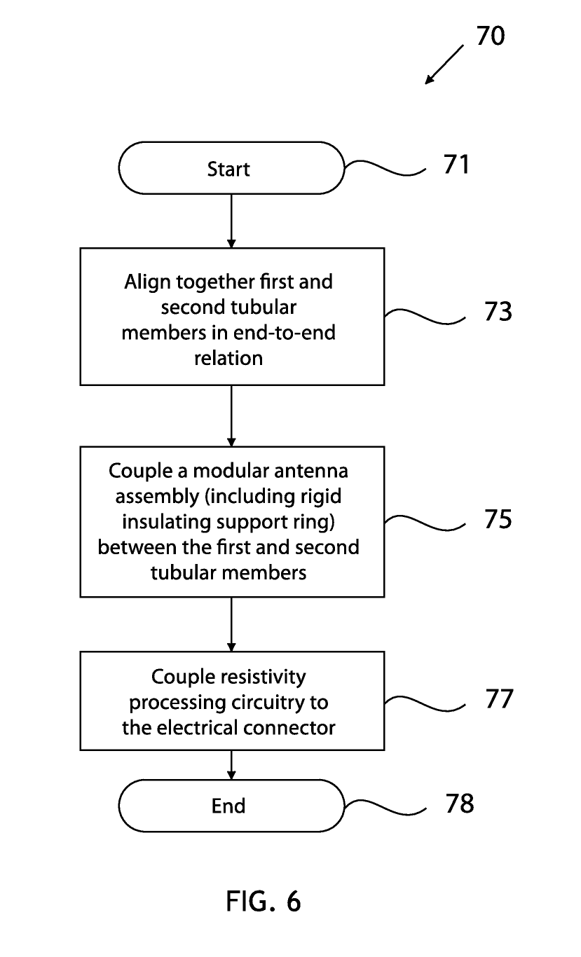

Referring now additionally to FIG. 6, a flowchart 70 illustrates a method of making a wellbore apparatus 20 (Block 71). The method includes coupling together first and second tubular members in end-to-end relation (Block 73), and coupling an antenna assembly between the first and second tubular members (Block 75). The antenna assembly includes a cylindrical housing having a circumferential recess therein, a rigid insulating support ring carried by the cylindrical housing in the circumferential recess, at least one antenna coil carried by the rigid insulating support ring, and an electrical connector coupled to the at least one antenna coil. The method also includes coupling resistivity processing circuitry to the electrical connector for determining an electrical resistivity of a wellbore based upon the at least one antenna coil (Blocks 77-78).

Other features relating to wellbore apparatuses are disclosed in co-pending application “REMOVABLE MODULAR ANTENNA ASSEMBLY FOR DOWNHOLE APPLICATIONS,” U.S. patent application Ser. No. 13/433836 , Attorney Docket No. IS11.0247, which is incorporated herein by reference in its entirety.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A wellbore apparatus comprising:
first and second tubular members aligned in end-to-end relation;
an antenna assembly coupled to at least one of said first and second tubular members and comprising
a cylindrical housing having a circumferential recess therein,
a rigid insulating support ring carried by said cylindrical housing in the circumferential recess,
at least one antenna coil carried by said rigid insulating support ring, and
an electrical connector coupled to said at least one antenna coil; and
resistivity processing circuitry coupled to said electrical connector to determine an electrical resistivity of a wellbore based upon said at least one antenna coil.

2. The wellbore apparatus of claim 1 wherein said rigid insulating support ring comprises a ceramic material.

3. The wellbore apparatus of claim 1 wherein said antenna assembly further comprises at least one member between said rigid insulating support ring and adjacent portions of said cylindrical housing.

4. The wellbore apparatus of claim 1 wherein said rigid insulating support ring directly contacts adjacent portions of said cylindrical housing.

5. The wellbore apparatus of claim 1 wherein said antenna assembly further comprises a first layer of insulating material between adjacent portions of said cylindrical housing and said rigid insulating support ring.

6. The wellbore apparatus of claim 1 wherein said antenna assembly further comprises a second layer of insulating material filling the circumferential recess.

7. The wellbore apparatus of claim 1 wherein said cylindrical housing comprises a reduced diameter portion having a diameter smaller than an inner diameter of said rigid insulating support ring.

8. The wellbore apparatus of claim 1 wherein said resistivity processing circuitry comprises a controller and at least one of a transmitter and receiver coupled thereto.

9. The wellbore apparatus of claim 1 wherein said at least one antenna coil comprises a plurality thereof

10. The wellbore apparatus of claim 1 wherein said antenna assembly comprises a modular antenna assembly coupled between said first and second tubular members.

11. The wellbore apparatus of claim 1 wherein said cylindrical housing is coupled around the at least one of said first and second tubular members.

12. An antenna assembly to be coupled onto a tubular member, the antenna assembly comprising:
a cylindrical housing having a circumferential recess therein;
a rigid insulating support ring carried by said cylindrical housing in the circumferential recess;
at least one antenna coil carried by said rigid insulating support ring; and
an electrical connector coupled to said at least one antenna coil.

13. The antenna assembly of claim 12 wherein said rigid insulating support ring comprises a ceramic material.

14. The antenna assembly of claim 12 further comprising at least one member between said rigid insulating support ring and adjacent portions of said cylindrical housing.

15. The antenna assembly of claim 12 wherein said rigid insulating support ring directly contacts adjacent portions of said cylindrical housing.

16. The antenna assembly of claim 12 further comprising a first layer of insulating material between adjacent portions of said cylindrical housing and said rigid insulating support ring.

17. The antenna assembly of claim 12 further comprising a second layer of insulating material filling the circumferential recess.

18. The antenna assembly of claim 12 wherein said cylindrical housing comprises a reduced diameter portion having a diameter smaller than an inner diameter of said rigid insulating support ring.

19. A method of making a wellbore apparatus comprising:
coupling together first and second tubular members in end-to-end relation;
coupling an antenna assembly to at least one of the first and second tubular members, the antenna assembly comprising
a cylindrical housing having a circumferential recess therein,
a rigid insulating support ring carried by the cylindrical housing in the circumferential recess,
at least one antenna coil carried by the rigid insulating support ring, and
an electrical connector coupled to the at least one antenna coil;
coupling resistivity processing circuitry to the electrical connector for determining an electrical resistivity of a wellbore based upon the at least one antenna coil.

20. The method of claim 19 wherein the rigid insulating support ring comprises a ceramic material.

21. The method of claim 19 wherein the antenna assembly further comprises at least one member between the rigid insulating support ring and adjacent portions of the cylindrical housing.

22. The method of claim 19 wherein the rigid insulating support ring directly contacts adjacent portions of said cylindrical housing.

23. The method of claim 19 wherein the antenna assembly further comprises a first layer of insulating material between adjacent portions of the cylindrical housing and the rigid insulating support ring.

24. The method of claim 19 wherein the antenna assembly further comprises a second layer of insulating material filling the circumferential recess.

25. The method of claim 19 wherein the cylindrical housing comprises a reduced diameter portion having a diameter smaller than an inner diameter of the rigid insulating support ring.

26. The method of claim 19 further comprising coupling a modular antenna assembly between the first and second tubular members.

27. The method of claim 19 further comprising coupling the cylindrical housing coupled around the at least one of the first and second tubular members.
